(19) United States
(12) Patent Application Publication
(10) Pub. No.: US 2005/0269884 A1
(43) Pub. Date: Dec. 8, 2005

(54) Electric tool

(75) Inventors: Takuya Teranishi, Ibaraki (JP); Shigeru Takahashi, Ibaraki (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Koki Co., Ltd., Tokyo (JP)

(21) Appl. No.: 11/100,612

(22) Filed: Apr. 7, 2005

(30) Foreign Application Priority Data
Apr. 9, 2004 (JP) P2004-116075

(51) Int. Cl. H02K 7/14

(52) U.S. Cl. 310/50; 310/58

(57) ABSTRACT

A shielding member is provided to cover the outer wall of the armature on a line segment connecting the inner wall at the front end of a magnet to the edge of a vent. The shielding member is ring-shaped and configured by a disk-shaped base section, a hole section formed at the center of the base portion, through which the armature can be passed, and a cylindrical section which extends forward from the base section. The shielding member is provided on the front of the yoke so that it is located apart from the magnet.

### BACKGROUND OF THE INVENTION

1. Field of the Invention

This invention relates to a technique for preventing dust particles from invading the interior of the motor of an electrical tool.

2. Description of the Related Art

There is a tendency of increasing a current passing through a motor in order to increase the power of an electrical tool. As a result, heat generation in the motor increases. In order to suppress the heat generation, a technique for improving the cooling efficiency has been developed (for example, JP-A-2002-254337). There is also a tendency of adopting a motor magnet having a higher energy density in order to increase the power of the electrical tool. As a result, leakage of a magnetic flux increases and iron powder is likely to invade. In order to suppress this invasion, a technique for reducing the leakage of the magnetic flux has beer developed (for example, JP-A-2004-80969).

There is the following description in the above JP-A-2002-254337. A electrical tool in a related art has a problem that an armature burns early. In order to solve this problem, between a carbon brush portion and the coil end of an armature, a metallic radiating plate having a shape along the coil end is located to form a wind path between the radiating plate and armature. Thus, cooling wind having a higher flowing velocity can be passed through the coil end serving as a heat source, thereby suppressing a temperature rise. Further, by holding this radiating plate so as to be attracted to a stator excited by a magnet, if iron powder invades together with the cooling wind, the iron powder is attracted to the excited radiating plate so that the motor operation can be stabilized.

There is the following description in the above JP-A-2004-80969. In recent years, in order to make the electrical tool compact, the outer diameter of a stator yoke is limited. However, if the outer diameter of the stator yoke is limited, the passage of the magnetic flux is also limited. This leads to a problem that the magnetic flux leaks from the outer wall of the stator yoke and side end of a magnet. This problem can be solved by extending an iron ring in an axial direction. But this lengthens the electrical tool. By providing iron members at the end faces of both sides of the stator yoke and magnet, the magnetic flux flows into the iron members so that the leakage of the magnetic flux can be reduced. Further, since the cooling wind is brown against the iron members, the heat radiating characteristic can be improved.

### SUMMARY OF THE INVENTION

If the electrical tool is installed at a place with more dust particles, as the case may be, the dust particles rise and invade the gap between the magnet and armature from a vent so that the operation of the motor is made unstable. Particularly, since the vent in the vicinity of a fan provided for cooling is often set to provide a larger opening than that in the other portion. The dust particles are likely to invade from this vent. The configurations proposed in JP-A-2002-254337 and JP-A-2004-80906 still give possibility that the iron particles may invade the gap between the magnet and the armature. An object of this invention is to improve the prior arts to provide an electrical tool in which iron particles are further difficult to invade.

The electrical tool according to this invention includes a housing of resin serving as an outer frame; a cylindrical yoke housed in the housing and formed of a ferromagnetic body such as iron; a magnet provided on the inner wall of the yoke; an armature rotatably supported by the housing with a gap itself and the inner wall of the magnet; a coil wound around the armature; a commutator provided more rearward than the yoke in the armature; a carbon brush being in slidable contact with the commutator; a fan provided more forward than the yoke in the armature; a vent which is a slot located in the vicinity of the fan in the housing, wherein a shielding member is provided to cover the outer wall of the armature on a line segment connecting the inner wall at the front end of the magnet to the edge of the vent by the shortest distance.

In accordance with this configuration, the shielding member can be provided at a position near the vent in the vicinity of the fan to cover the outer wall of the armature. Thus, dust particles such as iron powder are difficult to invade between the magnet and armature. Further, since the shielding member is not kept in contact with the magnet, it is not excited strongly and so does not attract more iron powder excessively.

In accordance with this configuration, the shielding member can be provided at a position near the vent in the vicinity of the an to cover the outer wall of the armature. Thus, the dust particles such as iron powder are difficult to invade between the magnet and armature. Accordingly, an electrical tool which can make the iron powder further difficult to invade can be provided.

In the above electrical tool, the shielding member is ring-shaped and has a disk-shaped base section, a hole section formed at the center of the base portion, through which the armature can be passed and a cylindrical section which extends forward from the base section, and the shielding member is provided on the front of the yoke so that it is located apart from the magnet.

In accordance with this configuration, the cylindrical section extends on a line segment connecting the gap between the magnet and armature. Thus, dust particles such as the iron powder which are to invade between the magnet and armature are blocked by the cylindrical section so that their invasion is interrupted. Further, since the shielding member is not kept in contact with the magnet, it is not excited strongly and so does not attract more iron powder excessively.

In accordance with this configuration, the dust particles such as iron powder are difficult to invade between the magnet and armature. Further, dust particles such as the iron powder which are to invade between the magnet and armature are blocked by the cylindrical section so that their invasion is interrupted. Further, since the shielding member is not kept in contact with the magnet, it is not excited strongly and so does not attract more iron powder excessively. Accordingly, an electrical tool which can make the iron powder further difficult to invade can be provided.

### BRIEF DESCRIPTION OF THE DRAWINGS

FIG. 1 is a front view showing the entire structure of an impact driver according to an embodiment of this invention;

FIG. 2 is a plan view showing the structure in the vicinity of a motor of the impact driver according to an embodiment of this invention;

FIG. 3 is a sectional view showing an example of a shielding member according to an embodiment of this invention;

FIG. 4 is a sectional view showing another example of a shielding member according to an embodiment of this invention

FIG. 5 is a plan view showing the structure in the vicinity of a motor of the impact driver according to an embodiment of this invention;

FIG. 6 is a plan view showing the structure in the vicinity of a motor of the impact driver according to another embodiment of this intention; and

FIG. 7 is a plan view showing the structure in the vicinity of a motor of the impact driver according to another embodiment of this invention.

### DESCRIPTION OF THE PREFERRED EMBODIMENTS

An explanation will be given of an embodiment of this invention applied to an impact driver 1.

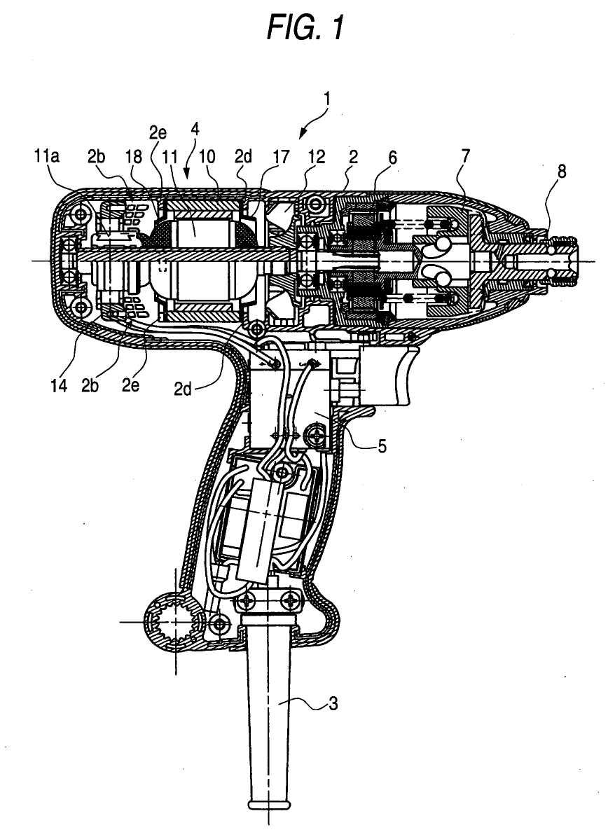

Referring to FIG. 1, the outline of the impact driver 1 will be explained.

The impact driver 1 includes an outer frame portion 2 serving as an outer frame; a power source cord 3 connected to the outer frame portion 2; a motor 4 which is rotated by electric power supplied from the power source cord; a switch 5 for controlling supply/stop of the electric power to the motor 4; a decelerating mechanism portion 6 for transmitting the rotation of the motor 4; an impact mechanism portion 7 for generating intermittent impact torque by the rotating force transmitted from the decelerating mechanism portion 7; an anvil 8 which is a tip tool holding portion attached to the front of the impact mechanism portion 7; and a bit which is a tip tool detachably attached to the tip of the anvil 8.

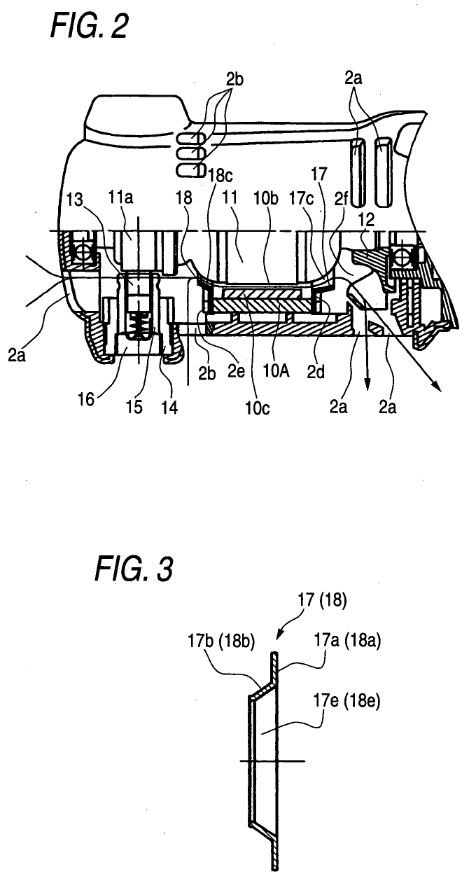

Referring to FIGS. 1 and 2, the motor 4 will be explained.

The motor 4 includes a stator 10 having a cylindrical yoke 10A and two magnets 10C fixed to the inner wall of the yoke 10A with a circumferential gap therebetween, an armature 11 passing inside the magnets 10C with a radial gap 10 and a centrifugal fan 12 secured to the armature 11. The stator 10 and armature 11 are accommodated in the outer frame portion 2. The centrifugal fan 12 is accommodated in a fan chamber 2f formed within the outer frame portion 2.

The motor 4 includes two carbon brushes 13 and a CB block 14. The carbon brush 13 is urged toward a commutator 11a attached to the armature to make commutation. The CB block 14 is made of resin and ring-shaped. The armature 11 is passed through the center slot (not shown) of the CB block 14. The CB block 14 holds two CB tubes 14, two CB caps 16 and a lead wire (not shown). The CB tube 15 is made by press-working a metallic thin plate. The CB tube 15 slidably holds the two carbon brushes 13. The CB cap 16 is made of resin and screw-engaged with the CB block 14 to serve as a stopper for the carbon brush 13.

The outer frame portion 2 is provided with a plurality of vents 2a, 2b and 2c. The vents 2a are a plurality of slots formed in a circumferential direction of the motor 4 at the positions adjacent to the outer periphery of the centrifugal fan 6. The vents 2b are a plurality of slots formed between the CB block 14 and stator 1 and in the circumferential direction of the motor 4. The vents 2c are a plurality of slots formed at the rear of the outer frame portion 2. The outer frame portion 2 provides a fan chamber 2d at the front of the stator 10 in which the centrifugal fan 12 can be housed.

The centrifugal fan 6 secured to the armature 11 is accommodated within the fan chamber 2f. The centrifugal fan 6 is provided with a plurality of protruding blades (not shown) in the circumferential direction. When the armature 11 is rotated, the air among the blades (not shown) of the centrifugal fan 12 is given a centrifugal force so that it flows from the inside to the outside in the radial direction.

Referring to FIGS. 2 to 5, an explanation will be given of a first shielding member 17 and a second shielding member 18.

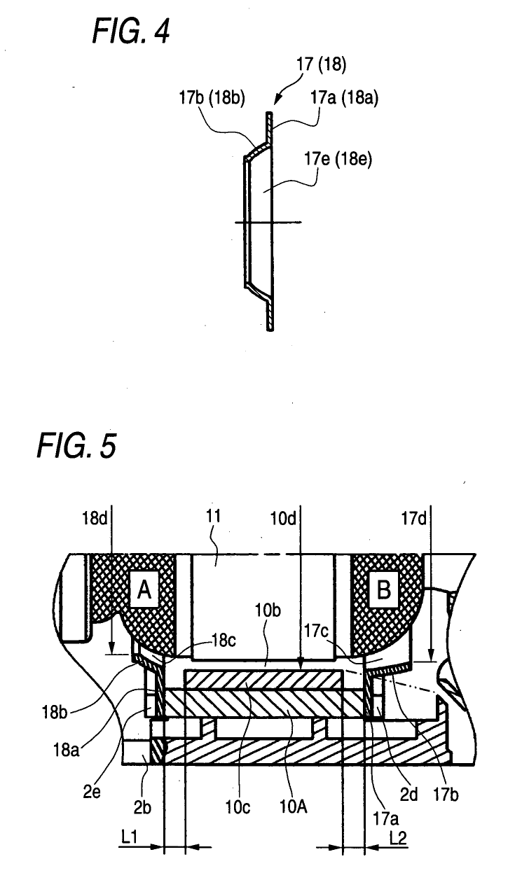

The first shielding member 17 is attached to the front of the yoke 10A. The first shielding member 17 is formed in a ring shape by press-working a metallic thin plate. The first shielding member 17 is configured by a disk-shaped base section 17a having a center hole 17e through which the armature 11 can be passed and a cylindrical section 17b which extends forward and an inner diameter decreasing forward The inner diameter of the cylindrical section 17b is slightly smaller than the inner diameter 10b of the magnet 10C. The cylindrical section 17b is set to extend more forward than a line segment connecting the inner wall at the front end of the magnet 10C to the edge of the vent 2a by the shortest distance (two-dot chain line in FIG. 5). The cylindrical section 17b may be formed with a linear gradient as shown in FIG. 3, or may be formed to become more steep toward its tip as shown in FIG. 4. The base section 17a is held to be sandwiched between the front end of the yoke 10A and the convex portion 2d projecting from the outer frame 2. The base section 17a is apart from the magnet 10C by a distance L2. As long as the distance is about 1 mm or more, the first shielding member 17 is not almost excited.

The second shielding member 18 is attached to the rear of the yoke 1A. The first shielding member 18 is formed in a ring shape by press-working a metallic thin plate. The second shielding member 18 is configured by a disk-shaped base section 18a having a center hole 18e through which the armature 11 can be passed and a cylindrical section 17b which extends rearward and an inner diameter decreasing rearward. The inner diameter of the cylindrical section 17b is slightly smaller than the inner diameter 10b of the magnet 10C. The cylindrical section 1b may be formed with a linear gradient as shown in FIG. 3, or may be formed to become more steep toward its tip as shown in FIG. 4. The base section 17a is held to be sandwiched between the front end of the yoke 10A and the convex portion 2d projecting from the outer frame 2. The base section 17a is apart from the magnet 10C by a distance L1. As long as the distance is about 1 mm or more, the first shielding member 18 is not almost excited.

An explanation will be given of the action of the dust particles when the impact driver 1 is located in the place with more dust particles and the effect of the embodiment of this invention.

When the impact driver 1 is put on the ground, the dust particles accumulated on the ground is stirred up in the air. Apart of the dust particles stirred up invades the fan chamber 2f. However, since the gap 10b is partially covered with the second shielding member 18, the dust particles do not almost invade the gap 10. In addition, since the yoke 10A is longer than the magnet 10c, less leakage of the magnetic flux occurs Further, since the second shielding member is apart from the magnet 10c, it will not be excited strongly. The scope of the magnetic force of the magnet 10C will not largely extend over the outer frame 2. The iron particles outside the outer frame 2 will not be attracted by the magnetic force of the magnet 10C.

An explanation will be given of the action of the dust particles when the impact driver 1 is operated in the place with more dust particles and the effect of the embodiment of this invention.

When the switch 5 is turned on, the armature 11 starts to rotate. The rotating force is reduced by the decelerating mechanism portion 6 and transmitted to the impact mechanism portion 7. The impact mechanism portion 7 intermittently gives impact torque to the anvil 8. And a tightened member such as a screw is tightened by the bit (not shown) attached to the anvil 8. At this time, less leakage of the magnetic flux emitted from the magnet 10C occurs so that a large output can be obtained.

Further, the centrifugal fan 6 also rotates. Correspondingly, as indicated by an arrow in FIG. 2, air flows into the fan chamber 2f from the vents 2b and 2c through the gap 18c formed between the second shielding member 18 and armature 11, gap 10b formed between the stator 10 and armature 11 and gap 17c formed between the first shielding member 17 and the armature 11. The flowing velocity of the air is relatively low until immediately before it flows in the gap 18c. However, once the air has flowed in the gap 18c, the flowing velocity increases because the sectional area of the flowing path is small. While the air is flowing through the gap 18c, gap 10b and 17c, the flowing velocity of the air is maintained at a high velocity. Thus, the armature 11 and stator 10 can be cooled effectively.

The air flowed out from the gap 17c flows into the fan chamber 2f. Since the air is given the rotating force by the centrifugal fan 6, the air flows outwards in the radial direction while it rotates around the rotating shaft of the armature 11. At this time, if the dust particles has been accumulated within the fan chamber 2f, they are exhausted externally from the vents 2a along the flow of the air.

An explanation will be given of another embodiment of this invention.

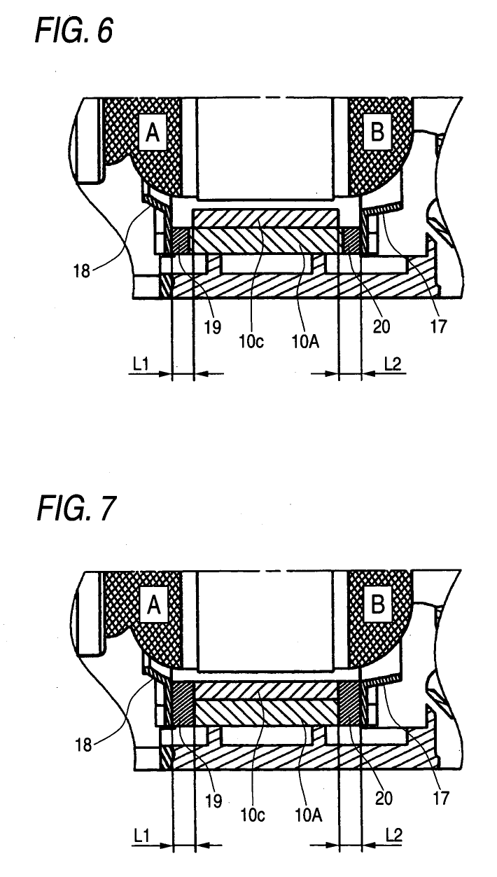

As shown in FIG. 6, the length of the yoke 10A may be shortened so that a resin spacer 19 is located between the first shielding member 17 and the yoke 10A and a resin spacer 20 is located between the second shielding member 18 and the yoke 10A. In this way, because leakage of the magnetic flux from the yoke 10A is increased, the iron powder put on the outer surface of the outer frame 2 is slightly increased. However, the first shielding member 17 and the second shielding member 18 become difficult to be excited so that the iron powder is difficult to invade the gap 10b. As shown in FIG. 7, also when resin spacers 21 and 22 may be located between the magnet 10C and the first shielding member 17 and second shielding member 18, the same effect can be obtained.

1. A electrical tool comprising:
a housing of resin serving as an outer frame;
a cylindrical yoke housed in the housing and formed of a ferromagnetic body such as iron;
a magnet provided on the inner wall of the yoke;
an armature rotatably supported by the housing with a gap itself and the inner wall of the magnet;
a coil wound around the armature;
a commutator provided more rearward than the yoke in the armature;
a carbon brush being in slidable contact with the commutator;
a fan provided more forward than the yoke in the armature;
a vent which is a slot located in the vicinity of the fan in the housing, wherein a shielding member is provided to cover the outer wall of the armature on a line segment connecting the inner wall at the front end of the magnet to the edge of the vent by the shortest distance.

2. An electrical tool according to claim 1, wherein the shielding member is ring-shaped and configured by a disk-shaped base section, a hole section formed at the center of the base portion, through which the armature can be passed and a cylindrical section which extends forward from the base section, and the shielding member is provided on the front of the yoke so that it is located apart from the magnet.
